(19) United States
(12) Patent Application Publication
(10) Pub. No.: US 2009/0113414 A1
(43) Pub. Date: Apr. 30, 2009

(54) Computer administration deployment system

(75) Inventor: Ken Hamilton, San Diego, CA (US)

Correspondence Address: THE NATH LAW GROUP, 112 South West Street, Alexandria, VA, 22314, US

(73) Assignee: TOTAL TECH INTERNATIONAL INC., San Diego, CA (US)

(21) Appl. No.: 12/010,684

(22) Filed: Jan. 29, 2008

Related U.S. Application Data
(60) Provisional application No. 60/996,004, filed on Oct. 24, 2007.

(51) Int. Cl. G06F 9/44

(52) U.S. Cl. 717/173

(57) ABSTRACT

One or more target computers have a supervisor-responsive program which permits remote administration by a supervisory computer's administrative website, and permits configuration, control and software management by an administrator through a supervisory computer accessible through a supervisory computer's administrative website. The supervisory computer allows administrators to login and manage which of one or more target computers should have security products provided by the supervisory computer. The supervisory computer's administrative website also delivers information about the effectiveness of the installed security products.

### RELATED APPLICATIONS

The present Patent Application claims benefit of Provisional Patent Application No. 60/996,004, which was filed on Oct. 24, 2007, by the inventors hereof and which is incorporated by reference herein.

### FIELD OF THE INVENTION

This subject matter relates to target computer program management. More specifically, the subject matter relates to managing installation, configuration and updating of computer programs and policies from a remote or central location.

### BACKGROUND

Software management is used for various administrative functions, including providing desired software installation and updates, managing programs to be installed in an enterprise environment, enforcement of update policies such as maintenance of currency of antivirus updates, and license management. This is done either on an individual basis, for example by the user subscribing to automatic updates or using an update maintenance program, or by a network manager through a LAN.

By way of example, it is common for antivirus programs and other software to frequently “call home” to obtain an update. The software provider provides information regarding one or more types of updates. In some configurations, the user can accept automatic updating, whereby the update is transmitted during operation, and the update installed when the program is opened or closed. Such techniques are often called “smart pull” methodologies. Examples of this technique include Mozilla Firefox, which can be set to periodically check for updates, and Grisoft AVG antivirus which regularly updates its database, and in the event that an update is available, retrieves the update and automatically installs the update. Some of these techniques are referred to as “smart pull” techniques.

Some computer companies allow for the remote delivery of software from a central location. The delivery of such software is generally controlled by the end user at the target computer, and not by an administrator working from a central location. A good example is Windows®(Microsoft Corp.) Update. When updates to Windows® software are ready, the user at the target computer is prompted to download a new version of the software via a popup window or on shut down. This is suitable for circumstances in which operation of the computer is intended to be under control of the user, but does not accommodate the need to control computers in a fully supervised environment.

Any interconnection among or between public, private, commercial, industrial, or governmental networks may be defined as an internetwork. In some network environments, programs and updates are provided to individual computers on a network by the server, according to a schedule determined by the system operator. Alternatively, administrators either write scripts that run on their network to deploy software, or manually go to each machine and install software.

There are various reasons for providing supervisory control of a computer. In some circumstances, enterprise computers are managed in a particular manner either because of the particular use of the computer or because of the nature of the business. There are cases in which a parent may wish to provide supervision of selected computer operation by a child. Examples would be access to subject matter or programs the parent considers undesirable and access to malware. It is also desired by individuals that a trusted entity manage their own computer, much in the manner that users use anti-spyware programs or antivirus programs. In these cases, the user or the owner of the computer may wish to have some program and configuration aspects of the computer managed externally.

It is possible to operate an enterprise network in which at least one computer is not connected to the administrator's computer or server via a LAN. In essence, that means that the target computers may be operating without the usual network program hooks that permit enterprise computer network management.

In addition, there are some instances where the owner of a computer may wish to manage another computer, such as a parent wishing to manage a computer belonging to a child. In such cases, the actual administration requires both knowledge of computer management and a general knowledge of available computer services. In many cases the parent will not know the specific nature of computer services or may not be aware of the ramifications of particular types of computer use. Common examples of this include file sharing sites and other sites which are used by criminals to install malware (typically advertising software) in victims' computers.

There are also configuration and software issues, in which the end user may wish to prevent particular types of use by others. An example would be the use of a computer by children, where the parent wishes to control the use within parameters defined by the parent. If the parent is unwilling or (more likely) unable to control the configuration of the computer, the parent may wish to provide full control to an outside service, who could manage the computer in accordance with the parent's instructions.

the case of “smart pull” technologies, the user configures the computer to initiate transactions on a regular basis. This requires that the updates be scheduled in a manner set by the user, with limited supervisory oversight. Such “smart pull” technologies further required configuration at the target computer, which generally makes it difficult to manage programs which are added to the computer independently of the supervisory oversight.

In contrast, an off-site webmaster can perform updates to a website by transmitting the changes to the server, typically by FTP, or through another file management technique. Thus, instead of waiting for a scheduled update time, the webmaster may make changes at random times. In some circumstances, the webmaster may make multiple updates within the timeout limits of a single FTP session. The update process is performed by remote changes to a website because most changes are of the nature of file substitution, rather than configuration of the underlying webserver program.

Another group of techniques for providing updates and configuration changes are referred to as “remote desktop” services. Remote desktop services can be either integral with the operating system or run through third part software, and allow a service technician to control operation of a computer, by use of the host software. Other than remote desktop services provide as part of the operating system, remote desktop software is typically written in Java. Remote desktop software permits the technician to manipulate the user's computer remotely and observe the user interface. The technique is useful with service calls but requires maintenance of the network connection throughout the session, and generally requires active operation of the computer using the user's display and control settings.

### SUMMARY OF THE INVENTION

A plurality of target computers are administered by a supervisory computer, in which the supervisory computer exercises supervisory functions related to software, configuration, software updates, and related aspects of the target computers.

In one aspect, a supervisory computer is used to control target computers which have control software installed. The supervisory computer is accessed and connection information concerning connection with a target computer is received, and a determination is made of a subscription state of the target computer relating to management of the target computer by the supervisory computer. If the target computer is not subject to a subscription, the administrative computer issues a command for the control software to either uninstall itself or release the control software to permit user uninstallation. This effects termination of supervisory operation for that target computer. If the target computer is a subscribed machine, a determination is made if the target computer has unauthorised software, in which case the unauthorised software is flagged for deactivation or is flagged for uninstalling. A determination of requirement to install new software is made, and in the case of a positive determination, a command is issued to download and install the new software, either from the supervisory computer or externally. A determination is made of a requirement to install software upgrades or updates, and similarly the upgrades or updates are handled in a manner similar to installation of new software. A determination is made concerning a requirement for configuration changes for the target computer, and if configuration changes are required, the configuration changes are effected. The requirement for configuration changes can be the result of user operation or changes in policy. A database is updated, concerning the status of the target computer in accordance with changes made to the target computer.

In a particular configuration, a software client is provided on at least one target computer to accept supervision by a supervisory computer. The software client causes the target computer to recognize a network connection by the computer and to connect to the network connection, and the target computer then communicates to the supervisory computer availability of communication by the software client. This provides an indication of a current address for the target computer. The target computer communicates information to the supervisory computer concerning configuration and software status concerning the target computer. The target computer receives control commands from the supervisory computer, and responds to the control commands by executing control commands to effect configuration and software changes on the computer running the software client.

### BRIEF DESCRIPTION OF THE DRAWINGS

The features and nature of the present subject matter will become more apparent from the detailed description set forth below when taken in conjunction with the drawings in which like reference characters identify correspondingly throughout and wherein:

FIG. 1 is a diagram showing an internetwork in which a supervisory computer communicates with remote computers, designated as target computers.

FIG. 2 is a diagram showing a process by which a supervisory computer is operated.

FIG. 3 is a representation of a typical display of an administrative process.

FIG. 4 is a flow diagram showing the operation of remote administration of a target computer.

### DETAILED DESCRIPTION

Overview

By use of “push” methodologies, it is possible for an administrator to determine the software and computer management policy on an “on the fly” or ad-hoc basis. The methodology permits enterprise management of computer management without the requirement for further network configurations.

In one implementation, individual target computers are addressable by a supervisory computer, which is able to address the target computers. This can be achieved by the target computers transmitting their present IP address or other address identifier. When it is desired to make configuration changes or updates, the supervisory computer addresses the target computer via the IP address, and uses the target computer to execute the change.

In a variant of this implementation, if a configuration change is to be made, and the target computer is not available, the supervisory computer flags the target computer in the supervisor computer's memory. When the target computer becomes accessible, the supervisory computer causes the configuration change to be made at that time.

Specific variations can be provided either as command variations or in the configuration of the supervisory software. For example, changes can be made selectively optional to the user, or changes can be effected during predetermined idle times for the target computer.

Internetwork Configuration

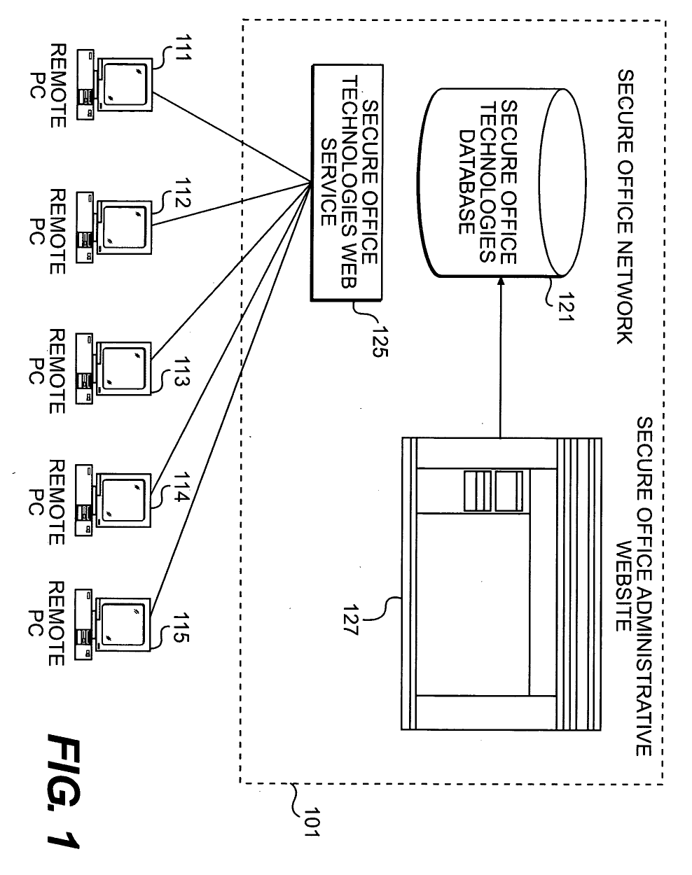

FIG. 1 is a diagram showing an internetwork in which a supervisory network 101 communicates with remote computers, designated as target computers 111-115. FIG. 1 depicts the supervisory network 101 as including a supervisory database 121, an administrative server 125, and an administrative web interface 127. Also depicted is a connection of the administrative server 125 to the target computers 111-115.

The supervisory network 101 comprises one or more supervisory computers (not separately shown) which are operated to control the various functions of the web interface 127. The web interface 127 is depicted in FIG. 1 as separate from the supervisory network because it is possible to provide supervisory service administration through a virtual connection and operate the supervisory network 101 separately from the administrative server 125.

The administrative server 125 uses the supervisory database 121 to determine the connection, program and configuration status of the target computers 111-115. The database 121 also includes information concerning the allowed configurations and programs for the target computers 111-115, either as a group, as sub-groups or individually. It is possible to provide program updates through the administrative server 125, or through external sources. Access to the administrative server 125 is through supervisory computer website, which can be accessed for control functions, as well as by users of the target computers for information concerning the supervisory functions. Additionally, the website can be used for obtaining changes, either directly through the administrative server or through program sources in the case of the changes requiring approval by the administrative server.

It is contemplated that much of the operation of the administrative server will be along permissive lines, whereby the users of the target computers will use the administrative server to verify the safety of programs and changes. In that case, the approval of changes may include input by users of the target computers.

Operation of System Administration

The technique leverages web services, a database, and administrative interface and services that install on target computers to deliver security software to target computers.

The deployment contains 2 distinct steps:

Step 1:
An administrator logs in to the supervisory computer's administrative website and selects a machine on which to install a product. This information is stored in the supervisor computer's database.

Step 2:
On a timed basis, a supervisor-responsive program module on the target computer calls the supervisory computer's web service. If information in the database changes, the supervisor-responsive program module on the target computer will download new software and install it on the target computer, or remove installed software from the target computer.

In order to select software for removal, one or more lists of acceptable programs and perhaps programs which are acceptable under some circumstances. For example there may be programs considered necessary for certain computers but which would not otherwise be authorised. By way of example, various programs exist that are used to resolve computer operability issues.

Administrative Website

The supervisory computer's administrative website 127 allows an administrator to login and manage which of the target computers should have security products provided by the supervisory computer. The supervisory computer's administrative website also delivers information about the effectiveness of the installed security products.

The administration process is carried out by the administrator. After the supervisor-responsive program module is installed on the target computer, the administration process requires no action from the end user. The administrator can install, remove and update supervisory computer's software on any machine that is connected to the internet and has the supervisory computer's supervisor-responsive program module installed.

The supervisory computer's technique accomplishes this by allowing administrators to configure which products and versions should or may be installed on the target machines at the administration website. Administrators can also configure when upgrades should be deployed and installed on the machines that they manage.

Program and configuration information for the target computers is stored in the supervisory computer's database. The supervisor-responsive program module on the target computer calls in to the supervisory computer's administrative website, from anywhere on the internet. When the supervisor-responsive program module on the target computer calls in to the supervisory computer's administrative website, the supervisory computer identifies which actions to take based what the administrator has configured.

Administration Process

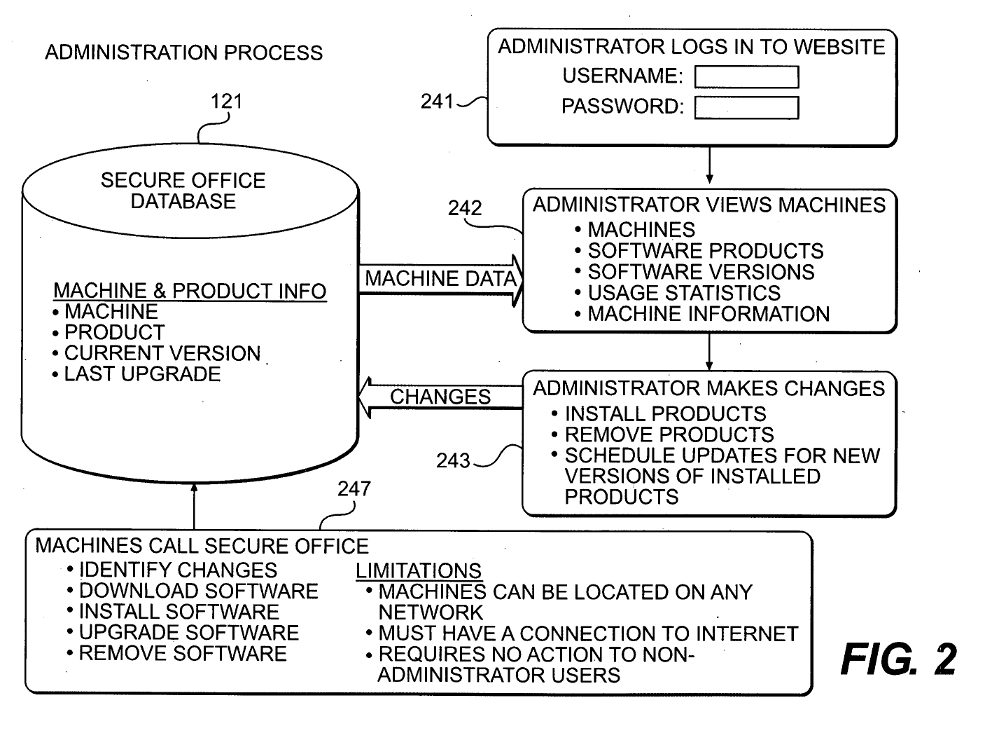

The supervisory network 101 is operated by the supervisory database 121, administrative server 125, and administrative web interface 127. FIG. 2 is a diagram showing a process by which a supervisory network is operated. The database 121 includes computer and software information, including the type of machine, its peripherals, software type, current version of the software, and last upgrade. Also included are authorised uses of the target computer, authorised software for installation on the computer, and authorised configuration changes. The database also includes operational information, such as connection status.

When the administrator logs onto the system (step 241), the database 121 supplies information (step 242) regarding the machines, software and configuration, as well as information regarding connections and update information. Also included is information concerning the operation of the target computer, so, for example, excess latency or inoptimal use of resources can be addressed.

The administrator, on viewing the information makes changes (step 243), such as program installation or upgrades, scheduling program changes, and configuration changes. The changes are provided to the database 121 and are used to effect the changes on the target computers.

The target computers effect connections to the system (step 247), at which time they identify changes, download software and updates, or obtain instructions to download software or updates, receive instructions to remove software, and receive instructions for configuration changes. The connections require a communication connection between the target computer and the supervisory computer, but do not require specific action on the part of the user.

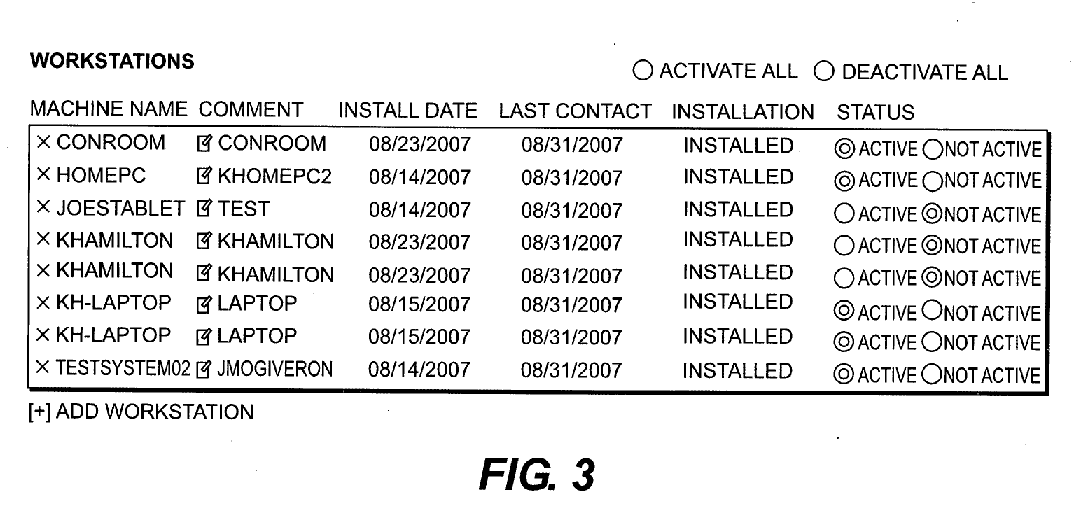

FIG. 3 is a representation of a typical display of an administrative process. The target computers are identified, as by machine name and comment. Installation and connection information are provided and status of control software on the target computer is displayed. A status indicator indicates the connection state of the target computers. Further information can be provided, typically by engaging other display screens through the administrator function.

Website Administration Interface

The administration interface is the means that the administrator uses to accomplish management of supervisory computer's software on remote machines. The interface in the screenshot shows management of the supervisory computer's administrative website. Among other things, the administrator can control the following via this interface:
1. add new machines to manage
2. remove machines to manage
3. add the remote filtering client to a machine (by clicking on “activate”)
4. remove the remote filtering client from a machine (by clicking on “deactivate”)

The technique also provides an ability to schedule updates and deploy updates.

Supervisor-Responsive Program Modules on Target Computers

When the software is deployed for the first time, a supervised program module is installed on the target PC. This supervised program module handles communications with the supervisory computer's web services.

This communication happens on a regular, but not predictable basis. For example, every 2-6 minutes, the supervisor-responsive program module on the target computer will call the web services layer. This is referred to as a “heartbeat”. Each time the supervisor-responsive program module calls the web services, a new time is sent back to the target computer indicating when it should call back again.

When the supervisor-responsive program module makes the call back to the supervisory computer web services, the supervisor-responsive program module checks for a number of things, including:
1. It checks to determine if it needs to remove itself from its status as a target computer in the case that an administrator has chosen to no longer manage the machine.
2. It checks to determine if the products it has already installed need to be removed.
3. It checks to determine if there are new products to install.
4. It checks to determine if there are any updates to install.

Based on the responses it gets, the supervisor-responsive program module will take the correct action. If a product needs to be removed, it will run the uninstall process for that product. If a new product needs to be deployed, it will download the product from the supervisory computer's network and run the install process for that product. The software and configuration changes occur without any user interaction on the target computer.

In some instances, a program is unidentified by the supervisory computer, or is flagged for manual supervision. If that is the case, the administrator can make a determination as to the desired disposition of the program and flag that program for either acceptance or deletion. An example of this would be certain types of control software used to effect operability fixes on particular computers.

The technique is able to remotely install and update software. The technique particularly includes:
1. The system allows administrators to deliver security software to machines that are not part of their network. Many administrators write scripts that allow them deliver software to machines that are on their network; however, if they want to deploy software to machines off of their network they need to find a different technique.
2. The technique of using the supervisory computer is different from standard computer update programs because the end user is not required to respond to a popup or otherwise participate in the change if deemed mandatory by the supervisor.

Administrative Process

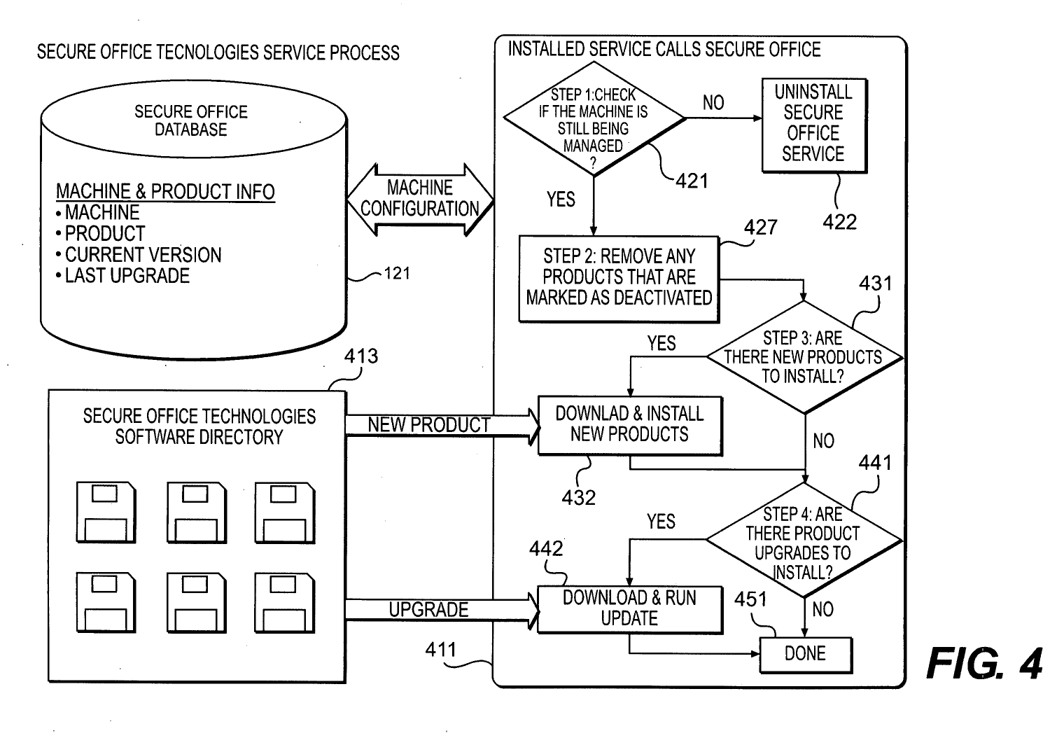

FIG. 4 is a diagram showing the operation of remote administration of a target computer 411. Also shown is a program store 413, which may be internal to the computer 411 or may comprise links to an unrelated site. In the case of a receipt of connection information from a target computer, the supervisory computer determines (step 421) if the target computer is intended to be managed. A determining of a subscription state of the target computer relating to management of the target computer is made. If the target computer is not supposed to be managed, for example because the user terminated the service contract, the supervisory computer issues a command for the control software to uninstall itself (step 422). Since, at least in some cases, the control software is programmed to prevent user override, communication of an uninstall command may be necessary to release the control software.

If the target computer is to be managed, the supervisory computer determines if the target computer has software that is either unauthorised, flagged for deactivation or flagged for uninstalling (step 427). The supervisory computer then determines (step 431) if new software is to be installed, and if new software is to be installed, issues commands (step 432) to download and install the new software. The software may be obtained from program store 413 provided by the supervisory computer or from an external source. The supervisory computer then determines (step 441) if software upgrades or updates are to be installed, and if software upgrades or updates is to be installed, issues commands to download and installs (step 442) the software upgrades or updates. The software may be obtained from a store provided by the supervisory computer or from an external source. The software then closes the connection (step 451).

Structural Alternatives

Currently, the target computers call back to the web services on a timed basis to determine if they need to take action. This is called a “smart-pull”. Alternatively, the database server could go into action when changes are made and send updates out to the target computers via a “push”.

The initial installation of the software occurs only on one target computer at a time. Alternatively, the installation could be written to look for other computers on a network and install on those machines as well.

The target computer may provide information to the supervisory computer's administrative website when the target computer establishes a suitable connection. Alternatively, the supervisory website can make its own determination as to when the target computer is available, for example by pinging the target computer. The disadvantage of relying on pinging the target computer is that the target computer may have a dynamic IP address. Regardless, once connected, pings can be used by the supervisory computer to determine the current connection status of the target computer's connection after an initial connection had been established.

The previous description of the disclosed embodiments is provided to enable any person skilled in the art to make or use the features, functions, operations, and embodiments disclosed herein. Various modifications to these embodiments may be readily apparent to those skilled in the art, and the generic principles defined herein may be applied to other embodiments without departing from their spirit or scope. Thus, the present disclosure is not intended to be limited to the embodiments shown herein but is to be accorded the widest scope consistent with the principles and novel features disclosed herein.

What is claimed is:

1. A software client capable of maintaining supervisory control by a remote supervisory computer comprising:
a software module capable of recognizing a network connection by the computer and connecting to the network connection;
a software module capable of communicating to a predetermined supervisory computer availability of communication by the software client, whereby the communication provides an indication of a current address for the computer running the software client;
a software module capable of communicating information to the supervisory computer concerning configuration and software status concerning the computer running the software client;
a software module capable of receiving control commands from the supervisory computer; and
a software module capable of responding to the control commands by executing control commands to effect configuration and software changes on the computer running the software client.

2. The software client of claim 1, further comprising:
a software module capable of, on a timed basis, effecting an internet connection to the supervisory computer, and in the case of a request from the supervisory computer to update or install software, downloading new software and installing the new software, and in the case of a request to remove from the supervisory computer, uninstalling the installed software.

3. The software client of claim 1, wherein the software client, upon connection with the supervisory computer:
determines if it needs to remove itself in the case that an administrator has chosen to no longer manage the machine;
determines if software already installed need to be removed;
determines if additional software requires installation; and
determines if any updates require installation.

4. The software client of claim 1, wherein the software client responds to the supervisory control from a predetermined external source external to a network on which the software client resides, thereby allowing the execution of the control commands to effect configuration and software changes on the computer running the software client without a local network connection and without a direct connection functionally equivalent to a local network connection.

5. The software client of claim 1, wherein:
the software client responds to the supervisory control from a predetermined external source external to a network on which the software client resides, thereby allowing the execution of the control commands to effect configuration and software changes on the computer running the software client without a local network connection and without a direct connection functionally equivalent to a local network connection, and wherein
the software client responds to the supervisory control without requiring a user to participate in the change in the case of the change deemed mandatory by a supervisor.

6. A method of managing a computer running a software client and having at least one type of network connection established on at least an intermittent basis, the method comprising:
recognizing a network connection by the computer and connecting to the network connection;
communicating to a predetermined supervisory computer availability of communication by the software client, whereby the communication provides an indication of a current address for the computer running the software client;
communicating information to the supervisory computer concerning configuration and software status concerning the computer running the software client;
receiving control commands from the supervisory computer; and
responding to the control commands by executing control commands to effect configuration and software changes on the computer running the software client.

7. The method of claim 6, further comprising responding to administrative commands whereby:
an administrator can
add new machines to manage,
remove machines to manage,
add the remote filtering client to a machine, or
remove the remote filtering client from a machine.

8. A method of administering target computers, the method comprising:
accessing a supervisory computer;
receiving connection information concerning connection with a target computer;
determining a subscription state of the target computer relating to management of the target computer;
in the case of the target computer not subject to a subscription, issuing a command for the control software to uninstall itself or for the control software to release the control software to permit user uninstallation, followed by termination of supervisory operation for that target computer;
in the case of the target computer subject to the subscription, determining if the target computer has unauthorised software, software flagged for deactivation or software flagged for uninstalling;
determining a requirement to install new software;
in the case of a positive determination of the requirement to install new software, issuing a command to download and install the new software;
determining a requirement to install software upgrades or updates;
in the case of a positive determination of the requirement to install software upgrades or updates, issuing a command to download and install the software upgrades or updates;
determining a requirement for configuration changes for the target computer;
in the case of a requirement for configuration changes for the target computer, effecting the configuration changes; and
updating a database of target computer status in accordance with changes made to the target computer.

9. The method of claim 8, further comprising:
determining whether the software for provision to the target computer, including new software, software upgrades and software updates, reside in a store provided by the supervisory computer or from an external source; and
providing the software or issuing a command to download the software accordingly.

10. The method of claim 8, wherein the software client, upon connection with the supervisory computer:
determines if it needs to remove itself in the case that an administrator has chosen to no longer manage the machine;
determines if software already installed need to be removed;
determines if additional software requires installation; and
determines if any updates require installation.

11. The method of claim 8, further comprising:
providing a software client on at least one target computer to accept supervision by the supervisory computer
causing the target computer to recognize a network connection by the computer and to connect to the network connection;
causing the target computer to communicate to the supervisory computer availability of communication by the software client, whereby the communication provides an indication of a current address for the target computer;
causing the target computer to communicate information to the supervisory computer concerning configuration and software status concerning the target computer;
causing the target computer to receive control commands from the supervisory computer; and
causing the target computer to respond to the control commands by executing control commands to effect configuration and software changes on the computer running the software client.

12. The method of claim 8, comprising causing the target computer to receive control commands from the supervisory computer, wherein the software client responds to the supervisory control from a predetermined external source external to a network on which the software client resides, thereby allowing the execution of the control commands to effect configuration and software changes on the computer running the software client without a local network connection and without a direct connection functionally equivalent to a local network connection.

13. The method of claim 8, comprising:
causing the target computer to receive control commands from the supervisory computer, wherein the software client responds to the supervisory control from a predetermined external source external to a network on which the software client resides, thereby allowing the execution of the control commands to effect configuration and software changes on the computer running the software client without a local network connection and without a direct connection functionally equivalent to a local network connection; and wherein
causing the software client to respond to the supervisory control without requiring a user to participate in the change in the case of the change deemed mandatory by a supervisor.

14. A system for administering target computers, comprising:
means for accessing a supervisory computer;
means for receiving connection information concerning connection with a target computer;
means for determining a subscription state of the target computer relating to management of the target computer;
means for issuing a command for the control software to uninstall itself or for the control software to release the control software to permit uninstallation in the case of the target computer not having an active subscription status;
means for determining if the target computer has unauthorised software, software flagged for deactivation or software flagged for uninstalling;
means for determining a requirement to install new software, and in the case of a positive determination of the requirement to install new software, issuing a command to download and install the new software;
means for determining a requirement to install software upgrades or updates, and in the case of a positive determination of the requirement to install software upgrades or updates, issuing a command to download and install the software upgrades or updates;
means for determining a requirement for configuration changes for the target computer, and in the case of a requirement for configuration changes for the target computer, effecting the configuration changes; and
means for updating a database of target computer status in accordance with changes made to the target computer.

15. The system of claim 14, further comprising:
means for determining whether the software for provision to the target computer, including new software, software upgrades and software updates, reside in a store provided by the supervisory computer or from an external source; and
means for providing the software or issuing a command to download the software accordingly.

16. The system of claim 14, further comprising:
means for checking to determine if it needs to remove itself in the case that an administrator has chosen to no longer manage the machine;
means for checking to determine if software already installed need to be removed;
means for determines if additional software requires installation; and
means for checking to determine if any updates require installation.

17. The system of claim 14, wherein the software client responds to the supervisory control from a predetermined external source external to a network on which the software client resides, thereby allowing the execution of the control commands to effect configuration and software changes on the computer running the software client without a local network connection and without a direct connection functionally equivalent to a local network connection.

18. The system of claim 14, wherein:
the software client responds to the supervisory control from a predetermined external source external to a network on which the software client resides, thereby allowing the execution of the control commands to effect configuration and software changes on the computer running the software client without a local network connection and without a direct connection functionally equivalent to a local network connection, and wherein
the software client responds to the supervisory control without requiring a user to participate in the change in the case of the change deemed mandatory by a supervisor.
